(19) United States
(12) Patent Application Publication
(10) Pub. No.: US 2016/0128026 A1
(43) Pub. Date: May 5, 2016

(54) METHOD AND APPARATUS FOR RECEIVING SIGNAL IN HIGH-SPEED MOBILE NETWORK

(71) Applicant: ELECTRONICS AND TELECOMMUNICATIONS RESEARCH INSTITUTE, Daejeon (KR)

(72) Inventors: Dae Soon CHO, Daejeon (KR); IL Gyu KIM, Okcheon-gun (KR); Seung Chan BANG, Daejeon (KR)

(73) Assignee: ELECTRONICS AND TELECOMMUNICATIONS RESEARCH INSTITUTE, Daejeon (KR)

(21) Appl. No.: 14/804,579

(22) Filed: Jul. 21, 2015

(30) Foreign Application Priority Data
Oct. 29, 2014 (KR) 10-2014-0148693

(51) Int. Cl. H04W 72/04; H04W 24/02; H04W 74/00

(52) U.S. Cl. CPC H04W 72/042; H04W 74/006; H04W 24/02

(57) ABSTRACT

A method and an apparatus for receiving a signal in a high-speed mobile network are provided. In the case of receiving, by a moving terminal in a high-speed mobile network environment, signals transmitted from a plurality of base stations, a signal received through one antenna is decoded to generate a first symbol corresponding to a first signal transmitted from a first base station. The first symbol is subtracted from the received signal to acquire a modified received signal, and the modified received signal is decoded to generate a second symbol corresponding to a second signal transmitted from a second base station.

### CROSS-REFERENCE TO RELATED APPLICATION

This application claims priority to and the benefit of Korean Patent Application No. 10-2014-0148693 filed in the Korean Intellectual Property Office on Oct. 29, 2014, the entire contents of which are incorporated herein by reference.

### BACKGROUND OF THE INVENTION

(a) Field of the Invention

The present invention relates to a method and an apparatus for receiving a signal in a high-speed mobile network.

(b) Description of the Related Art

A mobile hotspot network (MHN) system has mainly focused on performing mobile communications on a high-speed group mobile object in a high-speed mobile network environment, and has been designed to be operated well in a line-of-sight (LOS) environment.

The MHN system basically uses two antennas in front and rear directions, and has a structure in which one antenna transmits/receives one data stream. The MHN system receives signals input from both directions, and is designed to receive independent signals from each antenna and process the received signals.

However, distances between a transmitting side transmitting a signal and both antennas are similar to each other, and therefore when a signal-to-noise ratio (SNR) is reduced, a case in which a signal which should be received by either one of the two antennas is input through the other antenna and the like may occur, such that the receiving performance and decoding performance may deteriorate.

Further, a non-LOS (NLOS) environment is inevitably present intermittently. In this case, receiving performance may deteriorate.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for receiving a signal having advantage of improving receiving performance in a high-speed mobile network environment.

An exemplary embodiment of the present invention provides a method for receiving, by a moving terminal in a high-speed mobile network environment, signals transmitted from a plurality of base stations, including: decoding a signal received through one antenna to generate a first symbol corresponding to a first signal transmitted from a first base station, in a state in which the terminal includes a plurality of antennas; subtracting the first symbol from the received signal to acquire a modified received signal; and decoding the modified received signal to generate a second symbol corresponding to a second signal transmitted from a second base station.

The received signal may include first downlink control indicator (DCI) information on the first base station and second DCI information on the second base station.

In the generating of the first symbol, the received signal may be decoded using the first DCI information to generate the first symbol, and in the generating of the second symbol, the modified received signal may be decoded using the second DCI information to generate the second symbol.

In the generating of the first symbol and the generating of the second symbol, minimum mean square error (MMSE) detection may be performed to estimate a symbol, a log likelihood ratio (LLR) value may be calculated using the estimated symbol, and the corresponding symbol may be generated using the calculated LLR value.

The terminal may receive the first DCI information and the second DCI information from the first base station. When the terminal moves, the first base station may be a base station which is located in a direction in which the terminal moves, and the second base station may be a base station which is located behind a direction in which the terminal moves.

Another embodiment of the present invention provides an apparatus for receiving, by a moving terminal in a high-speed mobile network environment, signals transmitted from a plurality of base stations, including: a detector estimating a symbol from a signal received through one antenna or an input modified received signal, in a state in which the terminal includes a plurality of antennas; a first decoder performing decoding based on one estimated symbol output from the detector to generate a first symbol corresponding to a first signal transmitted from a first base station; a first signal operator subtracting the first symbol from the received signal to acquire the modified received signal and provide the acquired modified received signal to the detector; a second decoder performing decoding based on the other estimated symbol output from the detector to generate a second symbol corresponding to a second signal transmitted from the first base station; and a second signal operator subtracting the second symbol from the received signal to acquire the modified received signal and provide the acquired modified received signal to the detector.

The received signal input to the detector may include first downlink control indication (DCI) information on the first base station and second DCI information on the second base station.

The detector may estimate and output the first symbol using the first DCI information and estimate and output the second symbol using the second DCI information.

The apparatus may further include: a first demapper calculating a log likelihood ratio (LLR) value using the estimated first symbol output from the detector and outputting the calculated log likelihood ratio (LLR) value to the first decoder; and a second demapper calculating a log likelihood ratio (LLR) value using the estimated second symbol output from the detector and outputting the calculated log likelihood ratio (LLR) value to the second decoder.

The terminal may receive the first DCI information and the second DCI information from the first base station. When the terminal moves, the first base station may be a base station which is located in a direction in which the terminal moves, and the second base station may be a base station which is located behind a direction in which the terminal moves.

The terminal may include a first antenna receiving a signal corresponding to the first base station and a second antenna receiving a signal corresponding to the second base station.

### BRIEF DESCRIPTION OF THE DRAWINGS

FIG. 1 is a diagram illustrating a high-speed moving network environment according to an exemplary embodiment of the present invention.

FIG. 2 is an exemplified diagram illustrating a case in which an antenna receives a signal which needs to be received by another antenna.

FIG. 3 is a diagram illustrating a concept of an iterative receiving algorithm according to an exemplary embodiment of the present invention.

FIG. 4 is a flowchart of a method for receiving a signal according to an exemplary embodiment of the present invention.

FIG. 5 is a diagram schematically illustrating an apparatus for receiving a signal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification, unless explicitly described to the contrary, the word “comprise” and variations such as “comprises” or “comprising” will be understood to imply the inclusion of stated elements but not the exclusion of any other elements.

Hereinafter, a method and an apparatus for receiving a signal according to an exemplary embodiment of the present invention will be described.

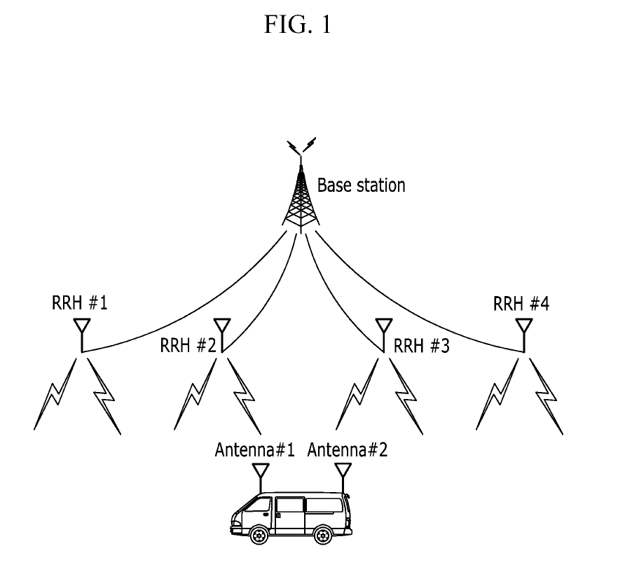

FIG. 1 is a diagram illustrating a high-speed moving network environment according to an exemplary embodiment of the present invention.

As illustrated in FIG. 1, in a high-speed mobile network environment, a signal transmitted from a base station 1 is transmitted to a mobile object 3 which moves at a high speed through wireless local area network (WLAN) base stations (represented by reference numeral “2”) which are hotspots formed at a plurality of positions.

The mobile object 3 uses two antennas to receive signals transmitted from the wireless local area network (WLAN) base stations 2. Each antenna independently receives and processes the signals transmitted from different wireless local area network (WLAN) base stations (e.g., RRH#2 and RRH#3). In this case, one antenna may often receive a signal received by the other antenna.

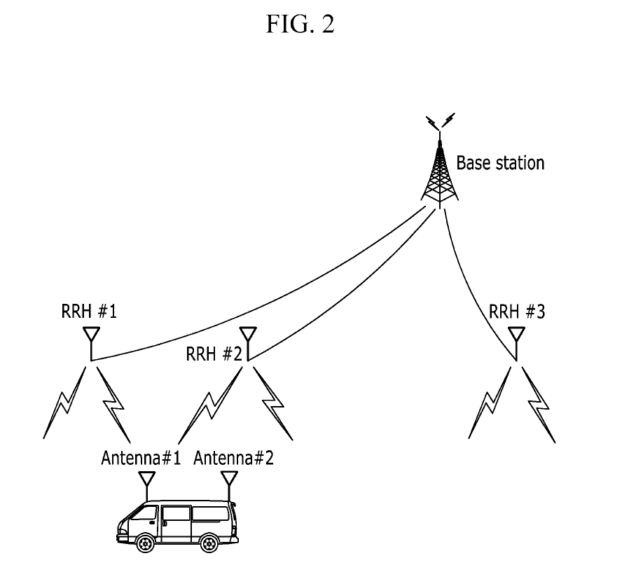

FIG. 2 is an exemplified diagram illustrating a case in which an antenna receives a signal which needs to be received by another antenna.

For example, as illustrated in FIG. 2, in the state in which the antenna #1 receives a signal from the wireless LAN base station RRH#1 and the antenna #2 receives a signal from the wireless LAN base station RRH#2, the antenna #1 may receive the signal from the wireless LAN base station RRH#2. In this case, interference occurs due to the signal received from the RRH#2 and thus demodulation performance of the antenna #1 deteriorates.

According to the exemplary embodiment of the present invention, to improve deterioration of the receiving performance, the signal receiving needs to be performed based on an iterative receiving algorithm.

Generally, to apply the iterative receiving algorithm, there is a need to transmit a multi-codeword. Data transmitted from a transmitting terminal of a recent mobile communications system support the multi-codeword, which is to allow a receiving terminal to perform demodulation and decoding and then cancel interference for each codeword and again perform the demodulation and decoding, thereby making the receiving performance good. To apply the iterative receiving algorithm, there is a need to transmit/receive the multi-codeword. In this case, in the high-speed mobile network environment, a mobile hotspot network (MHN) system transmits only one codeword and therefore it is difficult to apply the iterative receiving algorithm.

According to the exemplary embodiment of the present invention, in the high-speed mobile network environment, the mobile hotspot network (MHN) system performs the signal receiving based on the iterative receiving algorithm.

Next, a method for receiving a signal based on the iterative receiving algorithm will be described in more detail.

In the high-speed mobile network environment as illustrated in FIG. 1, when the antenna #1 demodulates the signal, the signal which needs to be input to the antenna #2 may often be input to the antenna #1. Herein, for convenience of explanation, the signal which needs to be input to the antenna #1 is called a “first input signal” and the signal which needs to be input to the antenna #2 is called a “second input signal”.

When the second input signal which is the signal which needs to be input from the antenna #1 to the antenna #2 is input, there is a need to know downlink control format indicator (DCI) information on the signal input to the antenna #2 to demodulate the second input signal.

Since a signal processing apparatus (for example, a modem) corresponding to the antenna #1 and the antenna #2 is in mobile bodies of the same group, according to the exemplary embodiment of the present invention, the signal processing apparatus which processes the signal received by the antenna #2 transmits the DCI information acquired by decoding the second input signal to the signal processing apparatus which processes the signal received by the antenna #1. The DCI information may include a codeword which is used at the time of data transmission processing.

The opposite case is possible. That is, even in the case of the first input signal which is the signal which needs to be input from the antenna #2 to the antenna #1, there is a need to know the DCI information on the first input signal. Therefore, the signal processing apparatus which processes the signal received by the antenna #1 transmits the DCI information acquired by decoding the first input signal to the signal processing apparatus which processes the signal received by the antenna #2.

In the above case, in each signal processing apparatus it is like receiving two streams, and therefore the iterative receiving algorithm is applied based thereon.

The method for receiving a signal based on the iterative receiving according to the exemplary embodiment of the present invention is as follows.

At the time of the iterative receiving algorithm, interference cancellation is essentially performed. The transmitting data generally include two code words, which is to allow the receiving side to cancel interference between each code word so as to improve the receiving performance. The received data are encoded with decoding data of the code word having a “good” cyclic redundancy check (SRC) of the two code words, a symbol is configured, and then the symbol is subtracted from the originally received signal, such that the signal of the other code word without interference may be regenerated. As a method for cancelling interference, there are a successive interference cancellation method, a parallel interference cancellation method, and the like.

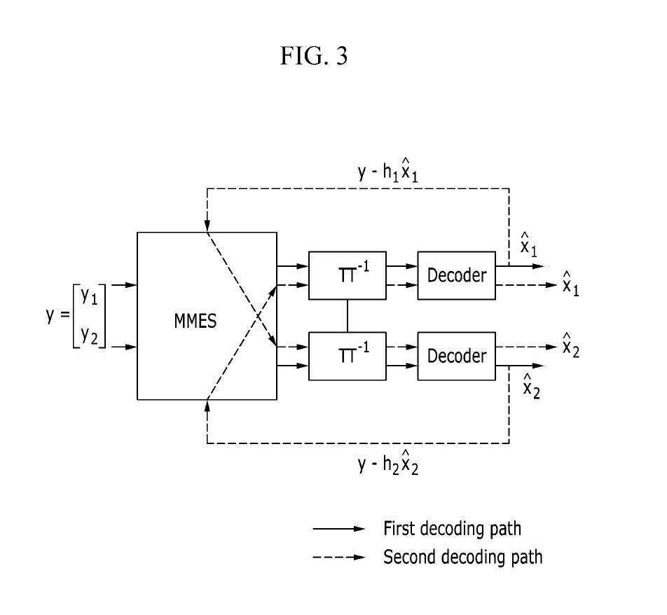

FIG. 3 is a diagram illustrating a concept of an iterative receiving algorithm according to an exemplary embodiment of the present invention.

When a MIMO transmitting/receiving system supporting spatial multiplexing has the multi-codeword, to make the performance of the receiving terminal good, the first demodulation and decoding is performed, the interference is iteratively cancelled, and then a demodulation and decoding algorithm is performed.

FIG. 3 illustrates that the interference cancellation is based on parallel interference cancellation (PIC), in which an operation of encoding, modulation, and the like which are originally performed by the transmitting terminal using data generated by the decoding result performed at the front stage is performed.

At the time of the first demodulation and decoding, the symbol in the received signal is estimated, a log likelihood ration (LLR) value is calculated based on the estimated symbol, and the decoding is performed based on the calculated LLR value.

At the time of the second demodulation and decoding, the symbol is again detected based on data acquired at the front stage, that is, at the time of the first demodulation and decoding, the LLR value is calculated, and the decoding is performed based on the calculated LLR value. By the process, the demodulation and decoding is performed with the symbol without the interference, therefore making performance better.

According to the exemplary embodiment of the present invention, in the case in which the first antenna and the second antenna of the mobile object moving at a high speed receive the signal transmitted from the base station, when a complex-valued symbol of the received signal is x(m), the received signal may be represented by the following Equation 1.

y=H·x+w (Equation 1)

In the above Equation 1, y may represent the received signal, H=[h₁, h₂, . . . , hₙ_{ₜ}] may represent a channel state matrix, x may represent the transmitted signal, and the complex-valued symbol of the transmitted signal may be represented by x(m). w represents additive white Gaussian noise (AWGN) depending on a Gaussian distribution in which a variance is σ²=Nvar and an average is 0.

A linear transform Ĝ which minimizes a mean-squared estimation error (MSEE) for the symbol of the transmitted signal may be represented by the following Equation 2.

$$\hat{x} = \hat{G} \cdot y and \hat{G} = arg {min}_{G} [ {‖ \hat{x} - x ‖}^{2} ] \qquad ( Equation 2 )$$

As a necessary condition for the transform, the following Equation 3 is established.

$$\begin{matrix}\frac{\partial }{\partial {G}^{*}} 𝔼 [ {‖ G y - x ‖}^{2} ] {\vert}_{\hat{G}} = 0 \\ ⇒ 𝔼 [ ( \hat{G} y - x ) \cdot {y}^{*} ] = 0 \\ ⇒ \hat{G} \cdot 𝔼 [ y {y}^{*} ] = 𝔼 [ x {y}^{*} ] \\ ⇒ \hat{G} \cdot ( H {H}^{*} + {σ}^{2} {I}_{4} ) = {H}^{*}\end{matrix} \qquad ( Equation 3 )$$

The channel state matrix H has a full-column rank and therefore the minimum mean squared error (MMSE) weight value matrix Ĝ may be calculated by the following Equation 4.

\hat{G}=(H*·H+σ²I)⁻¹·H* (Equation 4)

In the above Equation 4, A=H*·H+σ²I which is an operand of an inverse operation is a NumLyr-dimensional Hermitian matrix, and therefore Cholesky transform is performed on modified Gaussian elimination to easily decompose the A=H*·H+σ²I into L·D·L* of three matrixes. A=H*·H+σ²I Here, L is a lower triangular matrix of the same dimension and is a matrix in which all diagonal elements are 1. Further, D represents a real-valued diagonal matrix.

Decompositions may be sequentially performed row by row depending on the following equation. The LDU decomposition for the Hermitian matrix may be represented by the following Equation 5.

dᵢ=aᵢᵢ−Σ_{k<i}|lᵢₖ|²dₖ

lᵢⱼ=(aᵢⱼ−Σ_{k<j}l*ⱼₖlᵢₖdₖ)/dⱼ, for i>j (Equation 5)

The MMSE weight value matrix G may be calculated by a solution of the following simultaneous equation.

L·D·L*·Ĝ=H* (Equation 6)

In the above Equation 6, when B=L*·Ĝ, elements of the MMSE weight value matrix may be sequentially obtained depending on the following Equation 7.

bᵢⱼ=(h*ⱼᵢ−Σ_{k<i}lᵢₖdₖbₖⱼ)/dᵢ

ĝᵢⱼ=bᵢⱼ−Σ_{k>i}l*ₖᵢĝₖⱼ (Equation 7)

An output signal may be represented by the following Equation 8 based on the symbol \hat{x} estimated based on the MMSE weight value matrix and a function of noise variance.

Sym=\hat{x}/c OR Snr=c/(1−e) (Equation 8)

In the above Equation 8, a column vector c is as follows.

c=diag([I+σ²(H*·H)⁻¹]⁻¹)=diag(Ĝ·H) (Equation 9)

As such, the symbol is generated with the decoded result of the received signal. That is, the decoded result is encoded, a series of procedures which are performed by an encoder and a modulator of scrambling rate matching symbol mapping and the like are performed, and then the symbol is generated.

Here, assume that one is generated for an errorless codeword not having interference, that is, the CRC is “good”. In this case, when the errorless signal is subtracted from the originally received signal, a signal for a pure code word without other code word components may be generated. Therefore, when the MMSE is again detected with the data and the decoding is performed, the receiving performance is improved.

For this purpose, when the acquired symbol is subtracted from the received signal stored in the buffer, and the like, it is possible to acquire the signal without the interference. The symbol is estimated by again applying the foregoing MMSE detection operation to the signal without the interference, the LLR value is calculated using the estimated symbol and the SNR value, and the decoding is performed based on the LLR value, thereby re-generating a signal for the other code word without the interference.

According to the exemplary embodiment of the present invention, for the foregoing iterative receiving processing, the wireless local area network (WLAN) base station transmits DCI information on an adjacent wireless local area network (WLAN) base station in addition to its own DCI information at the time of the signal transmission. That is, in the environment as illustrated in FIG. 2, the wireless local area network (WLAN) base station RRH #1 simultaneously transmits the DCI information on the RRH#2 which is an adjacent base station in addition to its own DCI information. Further, the RRF#2 transmits the DCI information on the adjacent base station RRH#3 along with its own DCI information. Here, the wireless local area network (WLAN) base station transmits the DCI information on the adjacent base station, in particular, the base station corresponding to a just previous position, based on a direction that the high-speed moving object moves. The positional information of the forwarding mobile object may be predicted due to the characteristics of the MHN, and therefore the base station (for convenience of explanation, referred to as a previous base station) corresponding to the just previous position is confirmed based on the position information of the mobile object and the DCI information of the confirmed previous base station that are transmitted together.

Therefore, the mobile object performs the iterative receiving based on the DCI information received through the antenna at the time of receiving the signal.

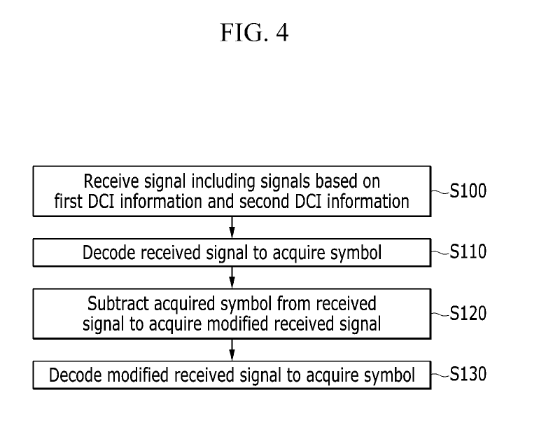

FIG. 4 is a flowchart of a method for receiving a signal according to an exemplary embodiment of the present invention.

The mobile object, that is, the terminal, performs the iterative receiving processing as described below on the signal received through one antenna. An example in which the signal is received through the antenna #1 and the received signal includes the first DCI information on the first base station (e.g., RRH#1) and the second DCI information on the second base station (e.g., RRH#2) will be described herein.

The terminal performs the MMSE detection as described above on the signal received through the antenna (e.g., antenna #1) to estimate the symbol based on the decoded result (S100 and S110). The decoding process based on the MMSE detection is described above and therefore the detailed description thereof will be omitted.

Here, when the symbol for the signal based on, for example, the first DCI information is generated by the decoding process, operation processing which subtracts the estimated symbol from the received signal which is an input signal is performed. That is, the terminal subtracts the symbol estimated based on the first DCI information from the received signal to acquire a signal without the signal based on the first DCI information. A signal without the signal based on the first DCI information in the received signal is referred to as a modified received signal (S120).

Further, for the modified received signal, as described above, the MMSE detection and decoding is again performed to acquire the symbol corresponding to the modified received signal (S130). By the above process, the transmitting data corresponding to the signal transmitted based on the first DCI information of the first base station (e.g., RRH#1) may be acquired from the signal received through the antenna #1. Further, for the signal obtained by subtracting the transmitting data from the received signal, the MMSE detection and decoding may be again performed to acquire the transmitting data corresponding to the signal transmitted based on the second DCI information of the second base station (e.g. RRH#2). Therefore, the transmitted data transmitted based on the first DCI information and the transmitting data transmitted based on the second DCI information may be acquired from the received signal.

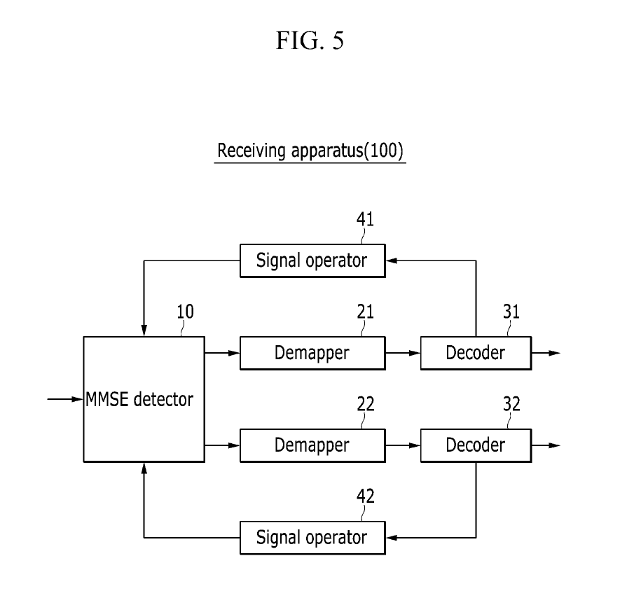

FIG. 5 is a diagram schematically illustrating an apparatus for receiving a signal according to an exemplary embodiment of the present invention.

As illustrated in FIG. 5, a receiving apparatus according to an exemplary embodiment of the present invention includes an MMSE detector 10, demappers 21 and 22, decoders 31 and 32, and signal operators 41 and 42.

The MMSE detector 10 estimates the symbol for the signal received through the antenna.

The demappers 21 and 22 acquire the LLR values using the estimated symbol and the decoders 31 and 32 decode the received signal using the LLR value to acquire the symbol.

The operation process of subtracting the symbol acquired from the signal operators 41 and 42 and the decoders 31 and 32 from the received signal is performed to generate the modified received signal and provide the generated modified received signal to the MMSE detector 11. In particular, the signal operators 41 and 42 may subtract the signal obtained by multiplying the acquired symbol by the channel value from the received signal to generate the modified received signal.

In detail, the demapper 21 calculates the corresponding LLR value based on the estimated symbol for the signal based on the first DCI information from the MMSE detector 11, and the decoder 31 uses the LLR value to generate the first symbol for the signal based on the first DCI information. The signal operator 41 provides the modified received signal acquired by subtracting the first symbol from the received signal to the MMSE detector 10. The first decoding process is completed by the above process, and thus the first symbol corresponding to the signal based on, for example, the first DCI information is generated from the received signal and the modified received signal without the first symbol is also acquired from the received signal.

Next, the second decoding process is performed based on the modified received signal. The estimated symbol acquired from the modified received signal is output to the demapper 22 from the MMES 10, and the demapper 22 calculates the corresponding LLR value and provides the calculated LLR value to the decoder 32. The decoder 32 performs the decoding using the LLR value to generate the second symbol for the modified received signal, that is, the signal based on the second DCI information.

The signal receiving processing may be identically performed on the received signals through the antenna #1 and the antenna #2, respectively.

According to an exemplary embodiment of the present invention, it is possible to improve the receiving performance by receiving a signal based on the iterative receiving algorithm in the high-speed mobile network environment.

The foregoing exemplary embodiments of the present invention are not implemented only by an apparatus and a method, and therefore may be realized by programs realizing functions corresponding to the configuration of the exemplary embodiment of the present invention or recording media on which the programs are recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for receiving, by a moving terminal in a high-speed mobile network environment, signals transmitted from a plurality of base stations, comprising:
decoding a signal received through one antenna to generate a first symbol corresponding to a first signal transmitted from a first base station, in a state in which the terminal includes a plurality of antennas;
subtracting the first symbol from the received signal to acquire a modified received signal; and
decoding the modified received signal to generate a second symbol corresponding to a second signal transmitted from a second base station.

2. The method of claim 1, wherein the received signal includes first downlink control indicator (DCI) information on the first base station and second DCI information on the second base station.

3. The method of claim 2, wherein in the generating of the first symbol, the received signal is decoded using the first DCI information to generate the first symbol and in the generating of the second symbol, the modified received signal is decoded using the second DCI information to generate the second symbol.

4. The method of claim 3, wherein in the generating of the first symbol and the generating of the second symbol, minimum mean square error (MMSE) detection is performed to estimate a symbol, a log likelihood ratio (LLR) value is calculated using the estimated symbol, and the corresponding symbol is generated using the calculated LLR value.

5. The method of claim 2, wherein the terminal receives the first DCI information and the second DCI information from the first base station.

6. The method of claim 5, wherein when the terminal moves, the first base station is a base station which is located in a direction in which the terminal moves, and the second base station is a base station which is located behind a direction in which the terminal moves.

7. An apparatus for receiving, by a moving terminal in high-speed mobile network environment, signals transmitted from a plurality of base stations, comprising:
a detector estimating a symbol from a signal received through one antenna or an input modified received signal, in a state in which the terminal includes a plurality of antennas;
a first decoder performing decoding based on one estimated symbol output from the detector to generate a first symbol corresponding to a first signal transmitted from a first base station;
a first signal operator subtracting the first symbol from the received signal to acquire the modified received signal and provide the acquired modified received signal to the detector;
a second decoder performing decoding based on the other estimated symbol output from the detector to generate a second symbol corresponding to a second signal transmitted from the first base station; and
a second signal operator subtracting the second symbol from the received signal to acquire the modified received signal and provide the acquired modified received signal to the detector.

8. The apparatus of claim 7, wherein the received signal input from the detector includes first downlink control indication (DCI) information on the first base station and second DCI information on the second base station.

9. The apparatus of claim 8, wherein the detector estimates and outputs the first symbol using the first DCI information and estimates and outputs the second symbol using the second DCI information.

10. The apparatus of claim 9, further comprising:
a first demapper calculating a log likelihood ratio (LLR) value using the estimated first symbol output from the detector and outputting the calculated log likelihood ratio (LLR) value to the first decoder; and
a second demapper calculating a log likelihood ratio (LLR) value using the estimated second symbol output from the detector and outputting the calculated log likelihood ratio (LLR) value to the second decoder.

11. The apparatus of claim 8, wherein the terminal receives the first DCI information and the second DCI information from the first base station.

12. The apparatus of claim 11, wherein when the terminal moves, the first base station is a base station which is located in a direction in which the terminal moves, and the second base station is a base station which is located behind a direction in which the terminal moves.

13. The apparatus of claim 11, wherein the terminal includes a first antenna receiving a signal corresponding to the first base station, and a second antenna receiving a signal corresponding to the second base station.
